(19) United States
(12) Patent Application Publication
(10) Pub. No.: US 2010/0261384 A1
(43) Pub. Date: Oct. 14, 2010

(54) ELECTRICAL CONNECTOR

(75) Inventor: Xue-Qing Zhang, Xuzhou (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/759,259

(22) Filed: Apr. 13, 2010

(30) Foreign Application Priority Data
Apr. 13, 2009 (CN) 200920147476.2

(51) Int. Cl. H01R 13/648

(52) U.S. Cl. 439/607.01

(57) ABSTRACT

An electrical connector comprises an insulating body with a front housing and a rear housing coupled together to form an accommodating portion. The front housing includes vertical tongue plate that supports a plurality of conductive terminals. The terminals include a contacting portion position on the tongue, a body portion position in the accommodating portion and a tail extending from the insulating body. A metal cover can be provided to cover the insulating body.

### BACKGROUND OF THE INVENTION

This application claims priority to Chinese Application No. 200920147476.2, filed Apr. 13, 2009, which is incorporated herein by reference in its entirety.

### TECHNICAL FIELD

The present invention relates to a connector and, in particular, to an upright electrical connector.

### BACKGROUND ART

Chinese Taiwan Patent Application No. 96219933 disclosed a well known electrical connector comprising an insulating body, a metal housing, and a plurality of conductive terminals, wherein the insulating body is provided with a tongue plate, and terminal grooves are provided on both sides of the tongue plate. The metal housing is assembled onto the insulating body. The conductive terminals are accommodated in the insulating body. Each conductive terminal is provided with a contacting portion which is arranged in the terminal groove, and a tail which extends out of the bottom surface of the insulating body.

However, this type of electrical connector suffers from certain issues. The insulating body employs a one-piece design, and is provided with a chamber which penetrates through the insulating body to the rear end face thereof. Since all of the conductive terminals have to run through the chamber to be fixed to the tongue plate, the electrical connector is rather difficult to assemble. In addition, once the conductive terminals are electrically connected with the circuit board, the one-piece insulating body still easily suffers from an external collision from the backside, and the conductive terminals are not well protected since the rear end of the chamber is opened. Furthermore, the contacting portion of the conductive terminal is shielded by a metal housing, but the tail is not shielded by a metal housing, so that the electrical connector is prone to have problems in the effectiveness of preventing electromagnetic interference (EMI). Therefore, certain individuals would appreciate an improved connector.

### SUMMARY OF THE INVENTION

An upright electrical connector is disclosed that includes an insulating body which comprises a front housing and a rear housing connected to the front housing. The front housing comprises a base portion, a vertical tongue plate extending forward from the base portion, and a plurality of terminal grooves being provided on the vertical tongue plate. A plurality of conductive terminals are provided, each of which comprises a body portion, a contacting portion which extending from one end of the body portion, and a tail extending from the other end of the body portion. The tails are configured to mount on a circuit board that forms a right angle with respect to the contacting portion, wherein the body portion is accommodated into the accommodating portion, the contacting portion is accommodated into the terminal groove, and the tail protrudes out of the bottom surface of the insulating body. If desired, a conductive shield can be provided to cover the insulating body and in if desired, the conductive shield can completely cover the insulating body to help reduce electromagnetic interference.

### BRIEF DESCRIPTION OF THE DRAWINGS

To further understand the features and technical aspects of the present invention, reference is made to the detailed description and the accompanying drawings of the present invention. However, the accompanying drawings are provided merely for the purpose of reference and description, but not as limitations to the present invention.

FIG. 1 is an assembled perspective view of an embodiment of an electrical connector;

FIG. 2 is an exploded perspective view of an electrical connector;

FIG. 3 is an exploded perspective view of an electrical connector shown in another angle of view;

FIG. 4 is an exploded perspective view of a front housing, a rear housing, conductive terminals, and a positioning plate of an electrical connector;

FIG. 5 is an exploded perspective view of a front housing, a rear housing, conductive terminals, and a positioning plate of an electrical connector shown in another angle of view;

FIG. 6 is a perspective view of a rear housing of an electrical connector.

### DETAILED DESCRIPTION OF THE PREFERRED EMBODIMENTS

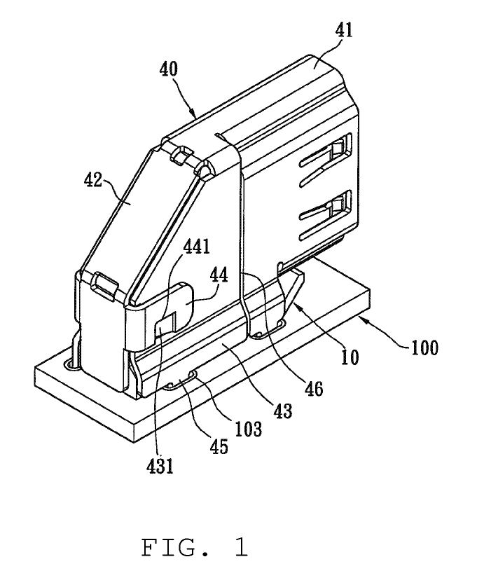

As shown in FIGS. 1-3, the depicted embodiment provides an upright electrical connector for being electrically connected with a circuit board 100. The circuit board 100 is provided with two positioning holes 101, a plurality of through holes 102, and four inserting holes 103, which penetrate through the circuit board 100. The electrical connector is not limited in any specification, and in the accompanying drawings, reference is made to an electrical connector that complies with a High-Definition Multimedia Interface (HDMI) specification. It should be noted that a similarly configured connector could be configured to comply with the DisplayPort specification. Thus, an appropriately configured connector could be configured for use with other specifications if desired. The upright electrical connector comprises an insulating body 10, a plurality of conductive terminals 20, a positioning plate 30, and a metal housing 40.

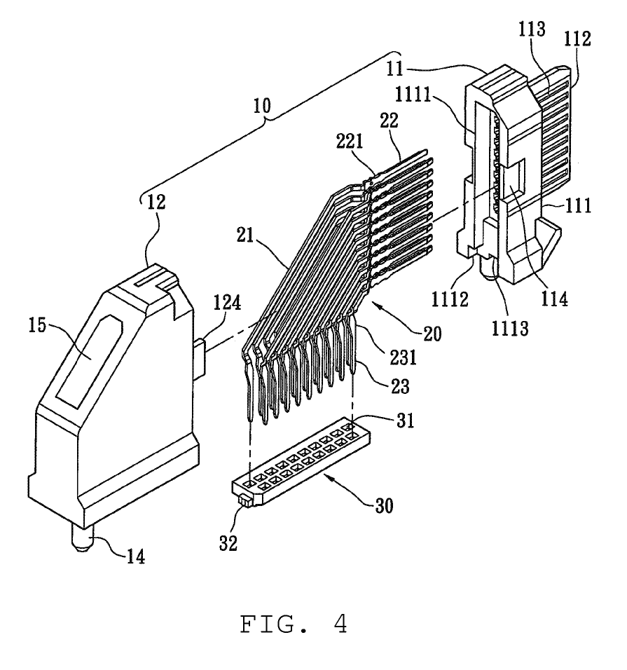

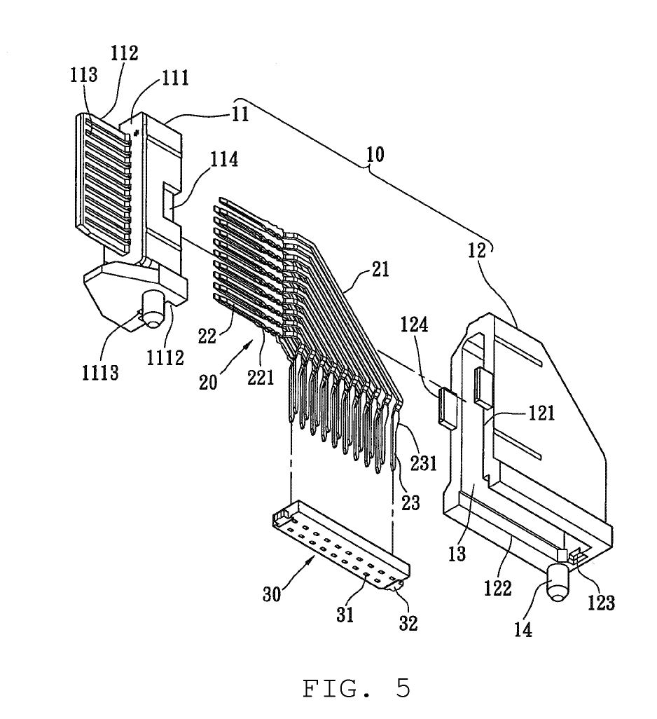

Referring to FIGS. 4-5, the insulating body 10 is designed into a two-piece style, and comprises a front housing 11 and a rear housing 12 which can be coupled together. The front housing 11 and the rear housing 12 can be assembled to provide a unitary structure that includes an accommodating portion 13 in the interior space between them. The bottom of the insulating body 10 can be further provided with two positioning columns 14 which are arranged at an interval. In the present embodiment, the two positioning columns 14 are provided on the bottom end face of the front housing 11 and the bottom end face of the rear housing 12 respectively.

The front housing 11 provides a mating interface for an opposing connector and includes a base portion 111, a vertical tongue plate 112 that extends for the base portion, and a plurality of terminal grooves 113 in the vertical tongue plate 112. The base portion 111 is provided with recess portions 114 on its both sides respectively, which extend to the rear end face of the base portion 111. The rear end face and the bottom end face of the base portion 111 are provided with a first opening 1111 and a second opening 1112 respectively. The second opening 1112 of the front housing 11 is provided with an embedding groove 1113 on the circumferential inner wall. The vertical tongue plate 112 is formed by extending forwards from the base portion 111. In the present embodiment, the terminal groove 113 are provided on the left and right side surfaces of the vertical tongue plate 112 at intervals, and extend to the rear end face of the base portion 111 to communicate with the accommodating portion 13. Of course, it is also possible to provide other configurations such as having the terminal groove 113 on only one side of the vertical tongue plate 112.

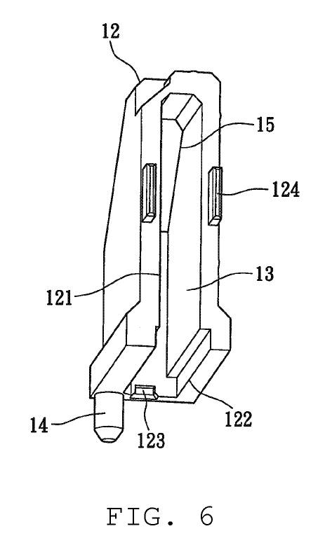

Referring to FIG. 6, the rear housing 12 is a hollow structure. Among the faces composing the rear housing 12, the front end face and the bottom end face are provided with a third opening 121 and a fourth opening 122, respectively, and the remaining faces are closed. The fourth opening 122 is also provided with an embedding groove 123 on the circumferential inner wall. The front end face of the rear housing 12 extends forward and includes two projections 124 which can be inserted correspondingly into two recesses 114 on the front housing 11.

Each conductive terminal 20 comprises a body portion 21, a contacting portion 22, and a tail 23. The contacting portion 22 is formed by extending forward from one end of the body portion 21, and at least one side of the contacting portion 22 is provided with a first fixing portion 221. The tail 23 is formed by extending downward from the other end of the body portion 21, so that the angle between the tail 23 and the contacting portion 22 is a right one. At least one side of the tail 23 is provided with a second fixing portion 231. In the depicted embodiment, the body portion 21 is connected between the contacting portion 22 and the tail 23, and extends in a direction inclined with respect to the horizontal plane.

It should be noted that, as can be appreciated from FIGS. 4-5, the depicted embodiment is configured so that the contacting portions are arranged in an alternating triangular signal, signal, ground configuration with one set of three terminals having the signal terminals on one side of the vertical tongue plate 112 and the ground on the other side and another set of three terminals having an inverted orientation. The depicted configuration allows the triangular arrangement to extend from the contact portions to the tails so as to help ensure the differential coupling between the signal terminals is maintained in a desirable manner. As can be appreciated, this will allow a route-out of signal traces from the terminals that can extend straight away from the two signal terminals on opposite sides, do a right angle turn and then head straight backward without having to route around vias used for ground terminals.

The positioning plate 30 is provided with a plurality of through holes 31 which penetrate the top and bottom surface of the positioning plate. The positioning plate 30 is further provided with two embedding blocks 32 on the two opposite sides thereof.

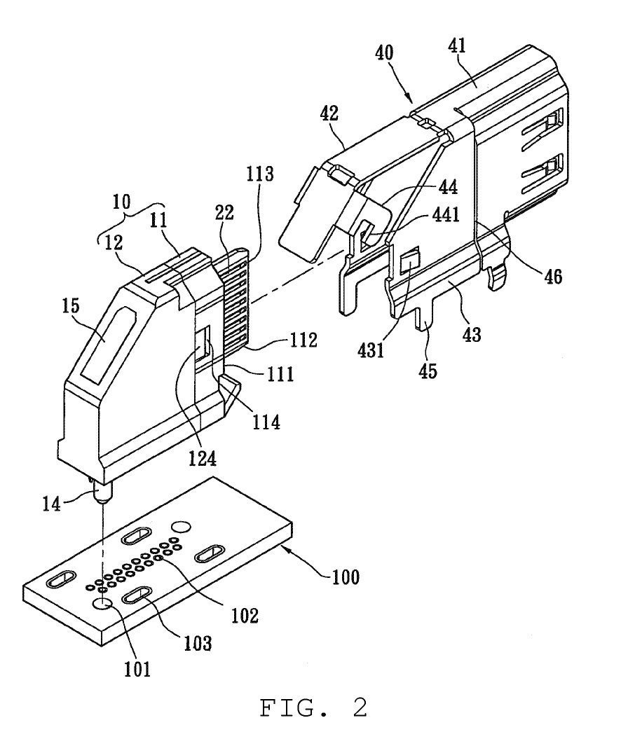

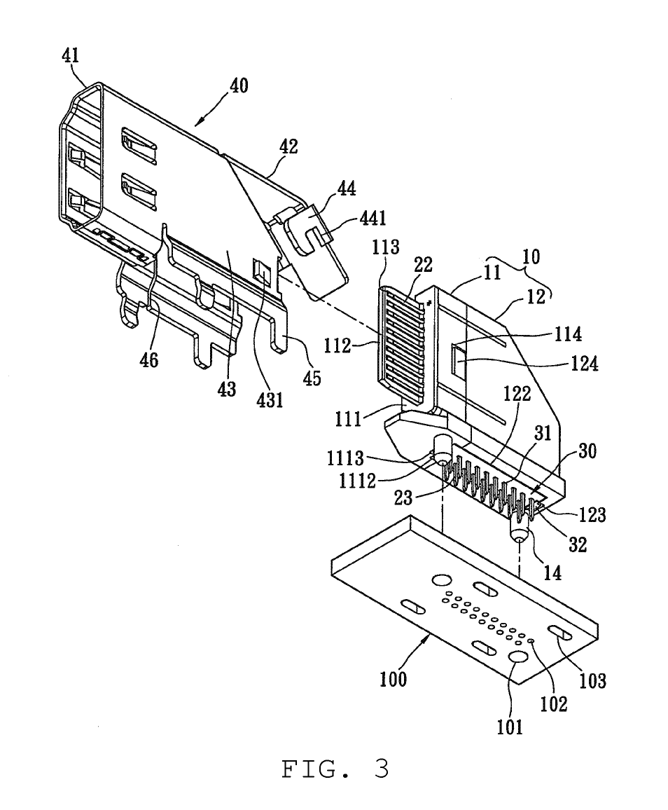

The metal housing 40 comprises a top wall 41, a rear wall 42, and two sidewalls 43 (referring to FIGS. 2-3). The rear wall 42 is bendable and connected with the rear end of the top wall 41, and both sides of the rear wall 42 bend and extend forward to form two fastening sheets 44. Each of the fastening sheets 44 is provided with a fastening notch 441. These two sidewalls 43 are formed by bending and extending downward from two sides of the top wall 41, and each of the sidewalls 43 is provided with a tab 431 at a position corresponding to the fastening notch 441, which as depicted, when engaged with the tab 431 is open ended and faces downward. As can be appreciated, the depicted bottoms of the two sidewalls 43 extend downward respectively to form two inserting sheets 45.

Referring to FIGS. 4-5, for assembling the electrical connector, the contacting portion 22 of each conductive terminal 20 is pushed in the forward direction and then accommodated into the terminal groove 113 of the front housing 11, and the first fixing portion 221 intervenes between the inner walls of the terminal groove 113 to fix the contacting portion 22. Then, two tabs 124 of the rear housing 12 are inserted correspondingly into two recess portions 114 of the front housing 11, and the wall surfaces of the tab 124 are tightly engaged with those of the recess portion 114. As a result, the rear housing 12 is clamped forward with the front housing 11 to constitute a closed insulating body 10, and the body portion 21 of the conductive terminal 20 is accommodated into the accommodating portion 13.

The tail 23 of the conductive terminal 20 penetrates through the through hole 31 of the positioning plate 30, and protrudes out of the bottom surface of the insulating body 10. The tail 23 of the conductive terminal 20 is fixed in position since the second fixing portion 231 intervenes with the inner wall of the through hole 31.

The two embedding blocks 32 of the positioning plate 30 are inserted into two embedding grooves 1113, 123 at the bottom portion of the insulating body 10 respectively and may have a friction fit to allow the positioning plate to be secured in place so that the positioning plate 30 is accommodated between the second opening 1112 in the bottom of the front housing 11 and the fourth opening 122 of the bottom of the rear housing 12.

Once assembled, the insulating body 10 can be fitted into the metal housing 40, (referring to FIGS. 2-3), so that the top wall 41 and two sidewalls 43 cover the top surface and two side surfaces of the insulating body 10. Then, the rear wall 42 of the metal housing 40 is bent downward to cover the rear end face of the insulating body 10, so that the fastening notches 441 of the two fastening sheets 44 are fastened from top to down with the convex body 431 of the two sidewalls 43, and the metal housing 40 covers the insulating body 10 to contain the front housing 11 and the rear housing 12. In this way, an embodiment of the upright electrical connector is completed.

Referring to FIGS. 1 and 3, when the depicted upright electrical connector is installed onto the circuit board 100, the two positioning columns 14 are inserted into the two positioning holes 101 so that the insulating body 10 can be accurately positioned onto the circuit board 100. The tail 23 of the conductive terminal 20 penetrates the through hole 102 so that the conductive terminal 20 is electrically connected with the circuit board 100. The inserting sheet 45 is inserted into the inserting hole 103, so that the metal housing 40 is fixed to the circuit board 100 and is electrically connected with the ground circuit of the circuit board 100 through the inserting sheet 45.

Moreover, further referring to FIGS. 4 and 6, provided that the conductive terminal 20 is not damaged, the closed surface of the rear housing 12 can be further provided with a cutout portion 15, which communicates with the accommodating portion 13, to dissipate heat from the electrical connector.

Moreover, further referring to FIG. 2, the metal housing 40 may also be further provided at its middle section with a cutting groove 46, which extends from the top wall 41 downward to the bottom surface of one of the sidewalls 43. In this manner, the rear half section of the sidewall 43 can be lifted upward during the assembly of the insulating body 10, and can be closed downward after the insulating body 10 is accommodated in the metal housing 40, so that it is convenient to mount the insulating body 10 into the metal housing 40.

Therefore, the depicted upright electrical connector can provide certain features and functions. For example, as depicted, the insulating body 10 can employ a two-piece design in which the insulating body 10 is composed of the front housing 11 and the rear housing 12. Therefore, it is relatively convenient to assemble the conductive terminals 20 in which the angle between the contacting portion 22 and the tail 23 is a right one. In addition, the front housing 11 and the rear housing 12 are coupled together to form the insulating body 10. As a result, even without the optional positioning plate 30, the insulating body 10 on the circuit board 100 can form a closed structure, which can further protect the conductive terminal 20 and reduce the possibility that the conductive terminal 20 is damaged due to collision. Furthermore, the metal housing 40 can cover substantially the whole insulating body 10, so that the body portions 21, the contacting portions 22 and the tails 23 of the conductive terminals are shielded by the metal housing 40 to provide a better effect in preventing the electromagnetic interference. In addition, provided that the conductive terminals 20 are sufficiently protected, a cutout portion 15 can be further provided in the closed surface of the rear housing 12 allow for heat dissipation.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

What is claimed is:

1. An electrical connector, comprising:
a front housing with a base portion, a vertical tongue plate extending forward from the base portion, and a plurality of terminal grooves being provided on the vertical tongue plate;
a rear housing connected to the front housing, wherein an accommodating portion is formed by the front housing and the rear housing and the front housing and the rear housing form an insulating body and the terminal grooves are in communication with the accommodating portion;
a plurality of conductive terminals, each of which comprises a body portion, a contacting portion extending from one end of the body portion, and a tail extending from the other end of the body portion and forming a right angle with respect to the contacting portion, wherein the body portion is positioned in the accommodating portion, the contacting portion is positioned into the terminal groove, and the tail protrudes out of bottom surface of the insulating body; and
a metal housing which substantially covers the insulating body.

2. The electrical connector of claim 1, wherein the insulating body covers the terminals between the contacting portion and the tail portions.

3. The electrical connector of claim 1, wherein the insulating body covers the terminals between the contacting portion and the tail portions except for a cutout portion in the rear housing that is in communication with the accommodating portion.

4. The electrical connector of claim 1, wherein the terminal grooves are provided on opposing first and second sides of the vertical tongue plate.

5. The electrical connector according to claim 4, wherein the electrical connector is configured to comply with the high-definition multimedia interface specification.

6. The electrical connector of claim 1, wherein both sides of the base portion of the front housing are provided with two recess portions which extend to a rear end face of the base portion, and a front end of the rear housing extends forward to form two projections which are correspondingly inserted into the two recess portions.

7. The electrical connector of claim 1, wherein the metal housing comprises a top wall, a rear wall connected to the top wall, and two sidewalls extending from the opposite sides of the top wall, wherein both sides of the rear include a fastening sheet that extends forward and includes a fastening notch extending from a bottom surface of the fastening sheet, wherein each of the sidewalls includes a tab at a position corresponding to the fastening notch respectively, wherein the fastening notches are coupled to the tab.

8. The electrical connector of claim 7, wherein the electrical connector is configured to comply with a high-definition multimedia interface specification.

9. The electrical connector of claim 7, further comprising a positioning plate that includes a plurality of through holes through which the tails penetrate, the positioning plate supported by a first groove in the front housing and a second groove in the rear housing.

10. The electrical connector of claim 7, wherein the electrical connector is configured to comply with a DisplayPort specification.

11. The electrical connector of claim 1, wherein the plurality of terminals are arranged in alternating triangular arrangement of signal, signal, ground terminals and the triangular arrangement extends from the vertical tongue to the tails.
